(19) United States
(12) Patent Application Publication
(10) Pub. No.: US 2017/0013807 A1
(43) Pub. Date: Jan. 19, 2017

(54) Pet Walking Pouch

(71) Applicant: John R. Johnson, Alpharetta, GA (US)

(72) Inventor: John R. Johnson, Alpharetta, GA (US)

(21) Appl. No.: 14/934,439

(22) Filed: Nov. 6, 2015

Related U.S. Application Data
(60) Provisional application No. 62/193,355, filed on Jul. 16, 2015.

(51) Int. Cl. A01K 27/00; A01K 23/00

(52) U.S. Cl. CPC A01K 27/003; A01K 23/00

(57) ABSTRACT

A tri-fold bag for containment of items while walking a pet, the tri-fold bag including a collapsible main compartment section made from a water-resistant flexible material having an opening opposite a base with drain holes, and foldable along its length. A cover flap is foldable over the opening for enclosing the main compartment section when open, and foldable over the tri-fold closed configuration. Fastener straps provide for attaching a shoulder strap or a leash to the tri-fold bag during the pet walk. The tri-fold bag includes a plurality of easily accessible secondary compartments for storage of personal items while walking the pet.

### CROSS-REFERENCE TO RELATED APPLICATIONS

This application claims the benefit of U.S. Provisional Application No. 62/193,355, entitled “A pet walking pouch designed for convenience in the collection and transport of pet waste,” filed Jul. 16, 2015, which is incorporated herein by reference as if set forth herein in its entirety.

### FIELD OF THE INVENTION

This invention pertains to pet waste disposal materials to provide additional convenience and waste transport when walking a pet. More particularly, this invention pertains to a foldable pouch having multiple compartments for unused waste disposal bags and soiled waste disposal bags, as well as for keys, cell phones, wallets, or other useful items, to be carried while walking a pet, particularly dogs.

### BACKGROUND

Recent studies suggest that United States households include 78 million dogs. As many as 40 percent of dog owners walk their dogs regularly. Percentages are even higher within the cities and suburbs. Common courtesy, if nothing else, suggests that the pet owner clean-up after their pet rather than leaving the pet waste behind for other unwary travelers. Many municipalities and communities have enacted laws that require a pet owner to clean up and remove pet waste from parks, common areas, sidewalks, walkways, and other areas. Many pet owners, and particularly dog owners, walk their pet using a leash, and typically also carry with them a bag or some other item for picking up and/or removing the waste after the animal has finished its business.

Once a bag has been used to retrieve the waste the owner is presented with a new problem. The owner is now carrying a bag of waste until a suitable disposal situation is encountered. Many people find it inconvenient, unappealing, and uncomfortable to carry or to be seen carrying a bag of waste. Placing the bag in one's pocket, or any other part of their clothing or personal effects is also undesirable. The owner may also desire to have available additional useful items such as car keys, a mobile phone, hand wipes, keys, a leash, treats, or even a toy for the walk. While such items may be placed in pants pockets, or jackets, a convenient way to manage these various items for a daily pet walk is not currently available. It is therefore desirable to have a pet walking accessory that includes a ready supply of unused waste bags, a compartment for storing soiled waste bags, as well as additional compartments for other useful items.

### BRIEF SUMMARY

According to one embodiment of the present invention, a pet walking pouch is provided that includes multiple compartments that provide storage for unused waste bags as well as personal effects that a person can keep with them while walking their pet. The pet walking pouch is foldable and unfolds via a tri-fold configuration to provide a large inner or main compartment for storage of soiled waste bags that contain any waste left by the pet during the walk.

In one embodiment, the pet walking pouch includes a pair of ring fasteners for attaching a shoulder strap for ease of carrying. In another embodiment, the shoulder strap also has capability to function as a leash if needed during the walk.

In one embodiment, the pet walking pouch includes a front storage compartment and a rear storage compartment for securing personal effects during a walk. The front and rear storage compartments may be of flexible material, or of mesh. In alternative embodiments, the front and rear storage compartments include fasteners for securing the contents placed therein.

The pet walking pouch is made from flexible materials such as a plastic covered and woven water-proof material, nylon, polyester, plastic, canvas, or other plain-woven fabrics, and/or any combination thereof that can be made water-resistant or water-proof.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 is a perspective view of a pet walking pouch;

FIG. 2 is a perspective view of the pet walking pouch with a detachable strap;

FIG. 3 is a perspective view of the pet walking pouch having a detachable leash that also serves as a strap;

FIG. 4 is a front view of the pet walking pouch;

FIG. 5 is a rear view of the pet walking pouch;

FIG. 6 is a top view of the pet walking pouch;

FIG. 7 is a bottom view of the pet walking pouch;

FIG. 8 is a front view of the partially-open pet walking pouch;

FIG. 9 is a front view of the completely-open pet walking pouch;

FIG. 10 is a rear view of the completely-open pet walking pouch;

FIG. 11 is a side view of the pet walking pouch;

FIG. 12 is a side view of the pet walking pouch with the front flap being lifted to open;

FIG. 13 is a side view of the pet walking pouch with the front flap being completely opened;

FIG. 14 is a side view of the pet walking pouch with the front flap being completely opened and the lower portion being folded down to expand and open;

FIG. 15 is a side view of the pet walking pouch with the front flap being completely opened and the lower portion being completely expanded and open;

FIG. 16 is a top view of the pet walking pouch with the lower portion completely expanded and open; and

FIG. 17 is a bottom view of the pet walking pouch with the lower portion completely expanded and open.

### DETAILED DESCRIPTION

A foldable pouch is provided for use while walking a pet, particularly dogs, and includes multiple compartments for unused waste disposal bags and soiled waste disposal bags, as well as for personal items such as keys, cell phones, and wallets.

Some recent studies suggest that United States households include 78 million dogs, and that as many as 40 percent of dog owners walk their dogs regularly. Percentages are likely even higher within the cities and suburbs. Common courtesy, if nothing else, suggests that a pet owner clean-up after their pet rather than leaving the pet waste behind for other unwary travelers. Many municipalities and communities have enacted laws that require a pet owner to clean up and remove pet waste from parks, common areas, sidewalks, walkways, and other areas. Many pet owners, and particularly dog owners, walk their pet using a leash, and typically also carry with them a bag or some other item for picking up and/or removing the waste after the animal has finished its business.

Once a bag has been used to retrieve the waste the owner is presented with a new problem. The owner is now carrying a bag of waste until a suitable disposal situation is encountered. Many people find it inconvenient, unappealing, and uncomfortable to carry or to be seen carrying a bag of waste. Placing the bag in one's pocket, or any other part of their clothing or personal effects is also undesirable. The owner may also desire to have available additional useful items such as car keys, a mobile phone, hand wipes, keys, a leash, treats, or even a toy for the walk. While such items may be placed in pants pockets, or jackets, a convenient way to manage these various items for a daily pet walk is not currently available. It is therefore desirable to have a pet walking accessory that includes a ready supply of unused waste bags, a compartment for storing soiled waste bags, as well as additional compartments for other personal and/or useful items.

Additionally, many existing bags or pouches are bulky and/or otherwise obtrusive or not sized conveniently for attaching to a dog leash or to one's belt for ease of use when walking a pet.

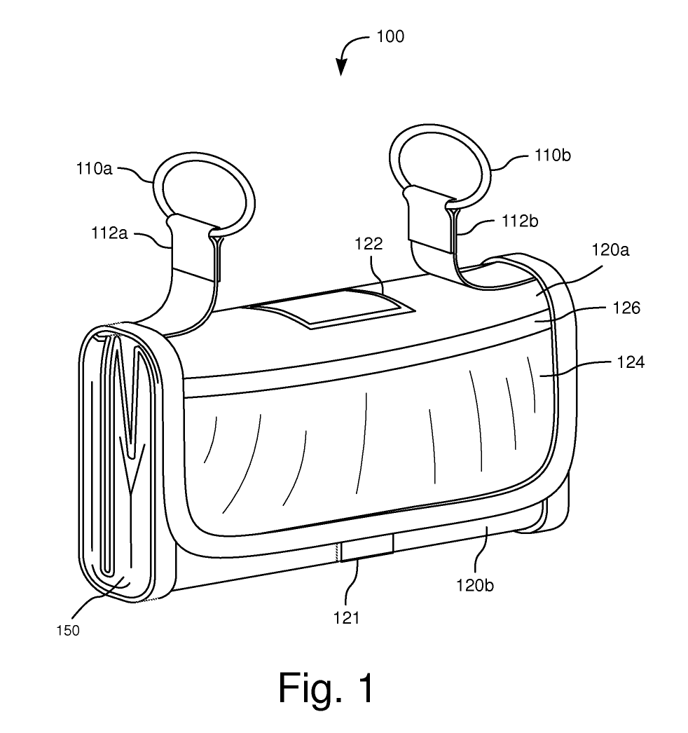

FIG. 1 is a perspective view of a pet walking pouch 100 for use when walking a pet, such as a dog. The pet walking pouch 100 includes multiple compartments that provide space for unused waste bags as well as personal effects that a person might want to keep with them while walking their pet. The illustrated embodiment of the pet walking pouch 100 unfolds or expands into a tri-fold configuration to provide a large main or inner compartment for storage of soiled waste bags that contain any waste left by the pet during the walk. When not in use, the pet walking pouch 100 is neatly compact for ease of carrying. A neatly compact configuration of the pet walking pouch 100 provides the added benefit of not having to deal with a bulky bag until one is ready to make use of the waste disposal features.

In the perspective view illustrated in FIG. 1, the pet walking pouch 100 is neatly folded into its smallest and least obtrusive compact configuration. In this compact or tri-fold configuration, a pair of fasteners 110a, 110b, together with a pair of fastener straps 112a, 112b, are visible and secured to a cover flap or over-panel 120a that folds over the front of the pet walking pouch 100. In the illustrated embodiment, the fasteners 110a, 110b are circular or “O-shaped” metallic rings having sufficient diameter to (1) extend through a wrapped portion of the respective fastener strap 112a, 112b, and (2) provide a ready location for attaching a clip to the pet walking pouch 100 for attachment of a strap, such as a shoulder strap, for ease of carrying the pet walking pouch 100. It should be understood that the fasteners 110a, 110b, could also be D-Rings, triangular rings, or any type plastic fastener, for example, suitable for securing to the respective fastener strap 112a, 112b and providing an attachment for a clip.

In the illustrated tri-fold configuration, the fastener straps 112a, 112b protrude upward from the top of either end 150 of the pet walking pouch 100. In the illustrated example, a fastener strap 112a, 112b extends from each end 150 of the pet walking pouch 100 and wrap around the fasteners 110a, 110b. Of course, as the pet walking pouch 100 is expanded or unfolded, the orientation of the fastener straps 112a, 112b will point outward or down. In one alternative embodiment (not shown), the pet walking pouch 100 includes only a single strap extending from one end 150 of the pet walking pouch 100. In such an embodiment, the single strap may extend from either end 150 of the pet walking pouch 100.

In one embodiment, the pet walking pouch 100 also includes an optional name or identification tag holder 122 affixed to the over-panel 120a and located between the fastener straps 112a, 112b. Existing waste disposal bags often do not include any accommodation for owner identification, which can be a problem in crowded parks. In one embodiment, the identification tag holder 122 includes a slot for sliding a name tag into the holder. The identification tag holder 122 is easily visible from any angle where the upper portion of the pet walking pouch 100 can be seen.

The front of the compact pet walking pouch 100 includes the over-panel 120a that folds downward to cover a portion of a folded under-panel 120b that folds upward and under the over-panel 120a. In one embodiment, the over-panel 120a includes a tab 121 for easily gripping and opening the over-panel 120a from a closed configuration. In one embodiment, the over-panel 120a also includes a front storage compartment 124 that is visible from the front of the compact pet walking pouch 100. In another embodiment (not shown), the over-panel 120a does not include a storage compartment, but rather is a plain cover flap as otherwise described above.

In the illustrated embodiment, the front storage compartment 124 is one of several storage compartments included as part of the pet walking pouch 100. In the illustrated embodiment, the front storage compartment 124 is open toward the upper portion of the compact pet walking pouch 100 and provides compact storage for such items as unused waste bags, keys, a small wallet, a cell phone, or any other personal effects that a person might desire to have easily available while walking a pet.

One benefit of the various storage compartments within the pet walking pouch 100 is that no special or proprietary waste disposal bags are required to fit within a proprietary dispenser. The user merely chooses an appropriate waste disposal bag, a group of bags, or a roll of bags, according to the user's preference and inserts the bags into a desired compartment. Of course, if the user does desire to place a particular dispenser within the compact pet walking pouch 100, the only limitation is whether it fits within one of the available storage compartments.

In the illustrated embodiment, an edge 126 along the upper portion of the front storage compartment 124 provides a visible demarcation of the opening of the front storage compartment 124. In the illustrated embodiment, the opening is not secured or fastened in any way and merely provides easy access for deposit and removal of the various effects which a person desires to temporarily store there.

In another embodiment, the front storage compartment 124 includes an edge 126 that is elasticized along the opening. The elasticized edge 126 provides for additional snugness so that the front storage compartment 124 is less likely to lose or spill its contents during use.

In yet another embodiment (not shown), the front storage compartment 124 includes an edge 126 that includes a fastener coinciding with the opening. In such an embodiment, a fastener is used to more securely seal the opening so that any effects stored therein cannot be lost during a walk when the fastener is in a closed configuration. It should be readily understood that there are many type fasteners that are effective for sealing such an opening, including but not limited to zippers, snaps, buttons, and hook-and-loop fasteners (such as VELCRO®), among others. It is intended that any and all such known fasteners be included within the scope of this disclosure.

The pet walking pouch is made from flexible materials such as a plastic covered and woven water-proof material, nylon, polyester, plastic, canvas, or other plain-woven fabrics, and/or any combination thereof that can be made water-resistant or water-proof.

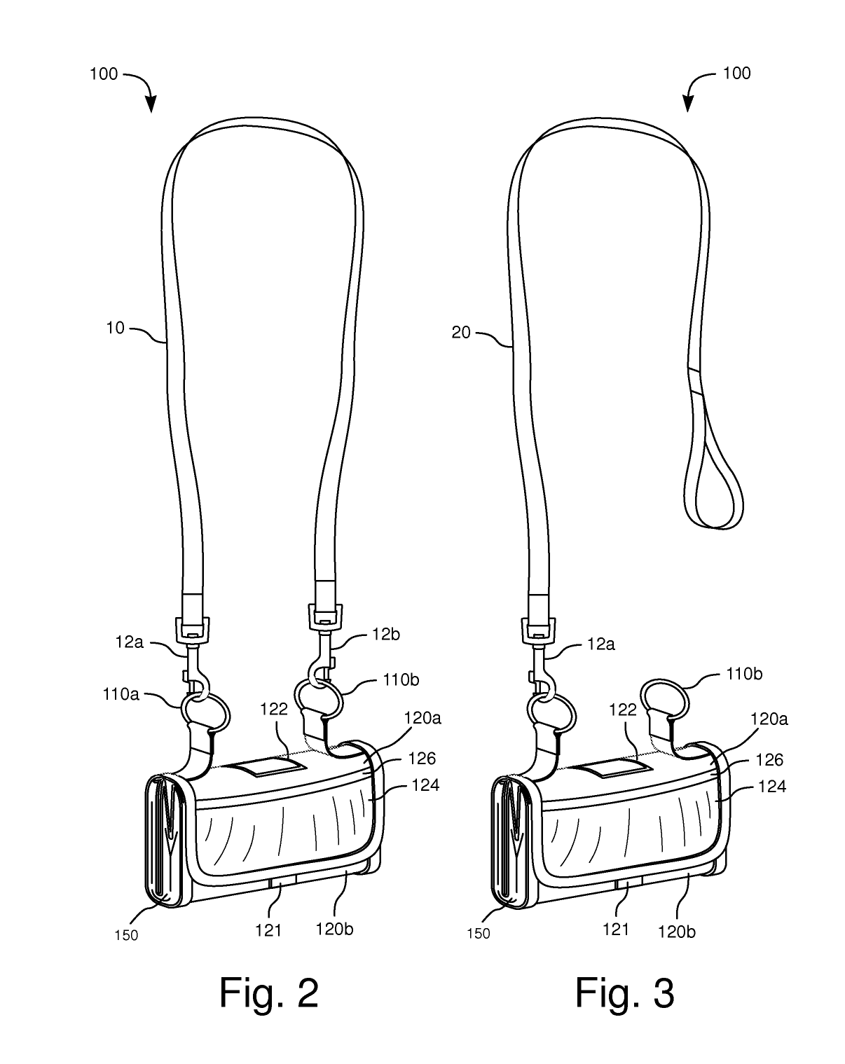

FIG. 2 is a perspective view of the pet walking pouch 100 with a detachable strap 10, such as a shoulder strap. FIG. 3 is a perspective view of the pet walking pouch 100 having a detachable leash 20, that can also serves as a strap. The detachable strap 10 includes a fastener clip 12a, 12b at either end for securing to the fasteners 110a, 110b of the pet walking pouch 100. The detachable leash 20 includes a single fastener clip 12a for securing to one of the fasteners 110a, 110b of the pet walking pouch 100. It should be noted that the fastener clips 12a, 12b can be any type carabiner, snap clip, swivel clip, or other clip, that is common for securing leashes or straps to fasteners such as rings, O-rings, D-rings, and such like. It is intended that any and all such known fastener clips be included within the scope of this disclosure.

In one exemplary use, a pet leash 20 is attached via fastener clip 12a to a fastener 110a, 110b of the pet walking pouch 100. In such an embodiment, the same fastener clip 12a is also attached to a clip on the pet's collar. In such an embodiment, the pet walking pouch 100 is secured near the neck portion of the pet during the walk, while also being unobtrusive to the person walking the pet.

In another exemplary use, each end of a shoulder strap 10 having fastener clips 12a, 12b at the respective end is secured to the pet walking pouch 100 at the fasteners 110a, 110b. In such a use, the pet walking pouch 100 is worn by a person just as in other shoulder type bag is worn, so that the pet walking pouch is conveniently available while being unobtrusive during a walk.

It should be understood that any number of available straps having the requisite fastener on at least one end, can be used with the pet walking pouch 100. Securing the pet walking pouch 100 while walking one's pet is limited only by the imagination of the pet owner and the available straps and fasteners. It is intended that any and all such fasteners and straps that can be used in conventional manner be included within the scope of this disclosure.

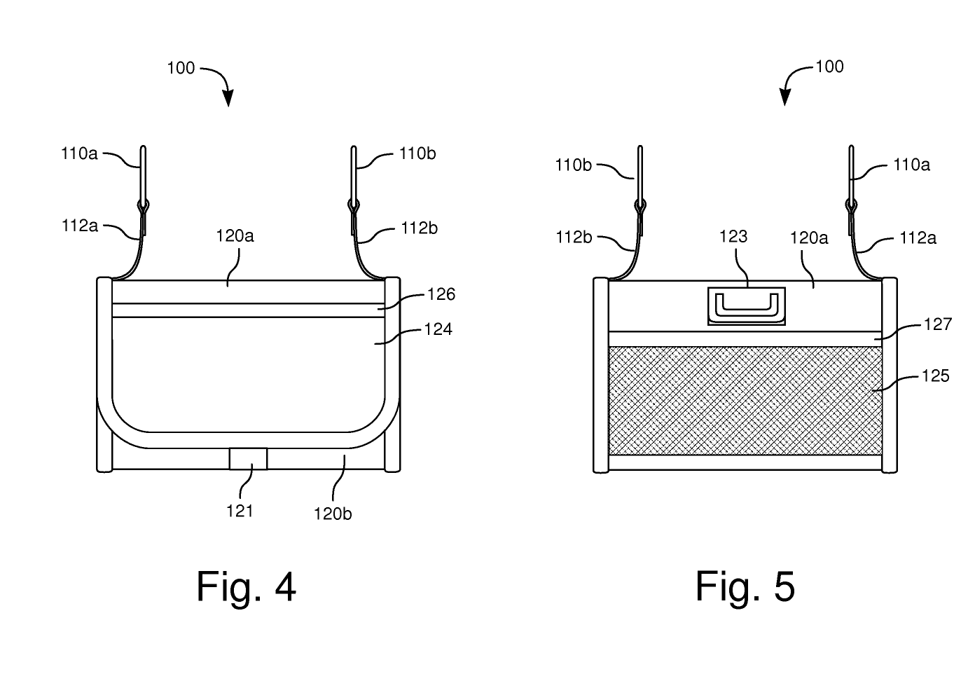

FIG. 4 is a front view of the pet walking pouch 100. In the illustrated front view of the pet walking pouch 100, the over-panel 120a is visible and extends downward to cover most of the folded upward under-panel 120b. The tab 121 extends from the over-panel 120a and provides a grip for opening the pet walking pouch 100. To open the pet walking pouch 100 from the folded configuration, one simply grips the tab 121 and/or the lower end portion of the over-panel 120a and lifts upward and/or away from the under-panel 120b.

FIG. 5 is a rear view of the pet walking pouch 100. The over-panel 120a extends over the top of the folded pet walking pouch 100. A portion of the over-panel 120a includes a rear storage compartment 125. In the illustrated embodiment, the rear storage compartment 125 includes a mesh covering. The mesh covering provides for visibility of any contents of the rear storage compartment 125. In another embodiment, the rear storage compartment 125 is a non-mesh covering similar to the over-panel 120a materials.

In the illustrated embodiment, the rear storage compartment 125 includes an edge 127 providing an additional visual demarcation of the opening of the rear storage compartment 125. In one embodiment, the opening is not secured or fastened in any way and merely provides easy access for deposit and removal of the various effects which a person desires to temporarily store there.

In another embodiment, the rear storage compartment 125 includes an edge 127 that is elasticized along the opening. The elasticized edge 127 provides additional snugness so that the rear storage compartment 125 is less likely to lose or spill its contents during use.

In yet another embodiment (not shown), the rear storage compartment 125 includes an edge 127 that includes a fastener coinciding with the opening. As noted above, in such an embodiment, a fastener is used to more securely seal the opening so that any effects stored therein cannot be lost during a walk when the fastener is in a closed configuration. It should be readily understood that there are many type fasteners that are effective for sealing such an opening, including but not limited to zippers, snaps, buttons, and hook-and-loop fasteners (such as VELCRO®), among others. It is intended that any and all such known fasteners be included within the scope of this disclosure.

In one embodiment, a belt fastener type clip 123 is affixed to the over-panel 120a near its top as viewed from the rear of the pet walking pouch 100 as illustrated in FIG. 5. The belt fastener clip 123 is used to secure the pet walking pouch 100 to one's belt, belt-line, or similar article, and to avoid the use of a shoulder or other type strap as discussed above.

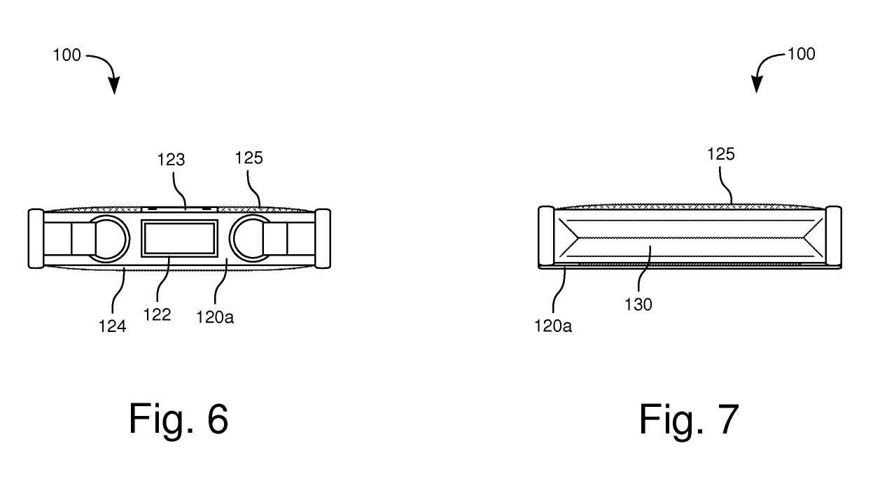

FIG. 6 is a top view and FIG. 7 is a bottom view of the pet walking pouch 100. The top view illustrates a front storage compartment 124 and a rear storage compartment 125 on the front and rear respectively of the folded pet walking pouch 100. Additionally, the identification tag holder 122 is located on the over-panel 120a between the ring fasteners 110a, 110b. In the illustrated view, the fastener straps 112a, 112b, and the corresponding ring fasteners 110a, 110b are stretched essentially flat against the over-panel 120a. The bottom view illustrates that the bottom or base 130 is compressed between the over-panel 120a and the rear of the pet walking pouch 100.

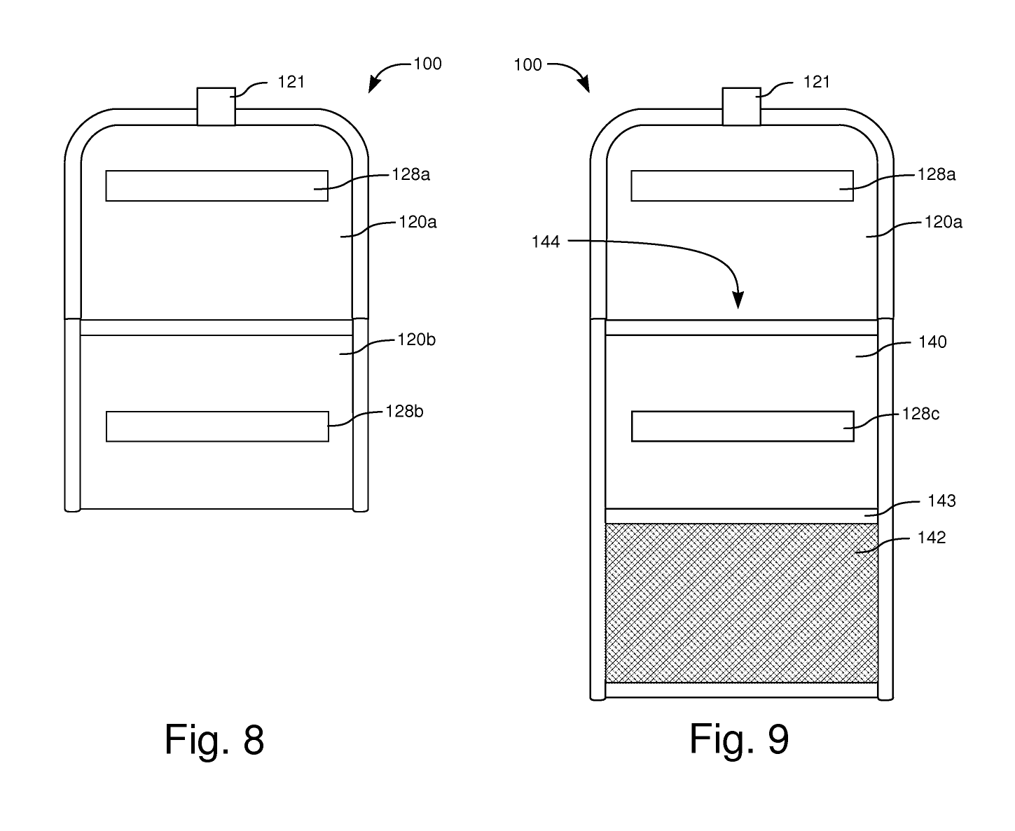

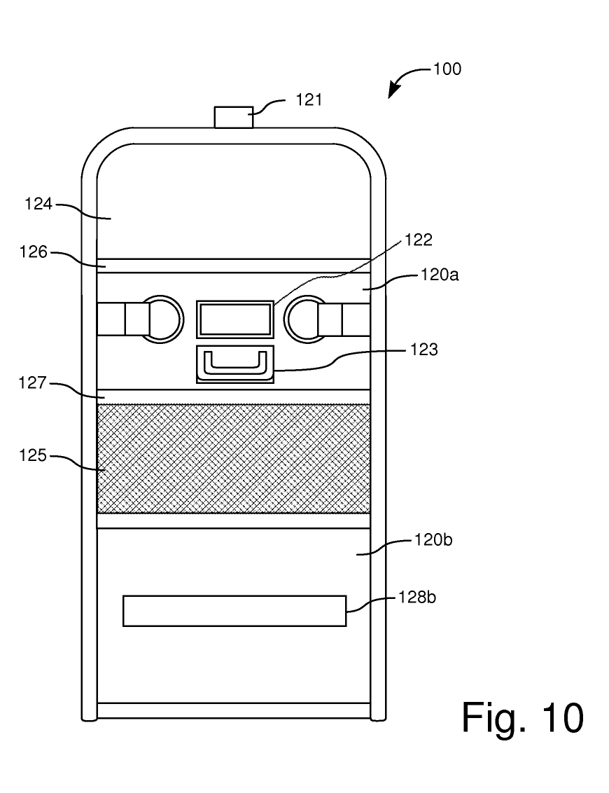

FIG. 8 is a front view of the partially-open pet walking pouch 100, FIG. 9 is a front view of the completely-open pet walking pouch 100, and FIG. 10 is a rear view of the completely-open pet walking pouch 100. In FIG. 8, the over-panel 120a is lifted upward and away from the under-panel 120b that is in a folded up configuration. It should be clear from this and previous illustrations that the over-panel 120a and the under-panel 120b extend from each other, extending from either side of and under the rear storage compartment 125. That is, in one embodiment, the over-panel 120a and the under-panel 120b are a single piece of material and are numbered separately to more clearly illustrate the respective locations as the under-panel 120b wraps up and encloses a portion of the inner-panel 140 as the pet walking pouch 100 is folded into the closed or smaller configuration.

As illustrated in FIG. 8, the under-panel 120b portion of the panel is folded upward and reveals a portion of the inside of the pet walking pouch 100 in the partially open configuration. In the completely closed configuration, a fastener 128a is pressed against fastener 128b to maintain the pet walking pouch 100 in the closed configuration. In FIG. 8, the over-flap 120a is folded upward so that both of these fasteners 128a, 128b are separated and visible in the partially open configuration. In the illustrated embodiment, the fasteners 128a, 128b are a matched pair of hook-and-loop fasteners. Of course, the fasteners, 128a, 128b could also be snap fasteners or any other fastener suitable for maintaining closure while also minimizing the thickness of the fastener to maintain the compactness of the pet walking pouch 100 in the closed configuration.

In the completely open front view of the pet walking pouch 100 illustrated in FIG. 9, an additional inside storage compartment 142 is revealed. An opening to a large main or inner compartment 144 for storing pet waste in soiled waste bags is apparent in the space between an inside panel 140 and the over-panel 120a. That is the over-panel 120a continues up from behind the inside panel 140.

The inside panel 140 includes an additional fastener 128c to which the fastener 128a on the over-panel 120a may be secured to close the inner compartment 144. The over-panel 120a serves as a lid to the inner compartment 144 container in this instance. In the illustrated embodiment, the pair of fasteners 128a, 128c also make a matched pair of hook-and-loop fasteners. It should be apparent that fastener 128a may be secured to either fastener 128b or to fastener 128c. Securing the fastener 128a to fastener 128b closes the pet walking pouch 100 in its compact or completely closed configuration, while securing the fastener 128a to fastener 128c closes the inner compartment 144 of the pet walking pouch 100 in its open configuration for the storage and transportation of soiled waste bags containing pet waste.

In the illustrated embodiment, the inside storage compartment 142 includes a mesh covering. The mesh covering provides for visibility of any contents of the inside storage compartment 142. In another embodiment, the inside storage compartment 142 is a non-mesh covering made from materials that are similar to the over-panel 120a or inside panel 140 materials.

In the illustrated embodiment, the inside storage compartment 142 includes an edge 143 providing an additional visual demarcation of the opening of the inside storage compartment 142. In one embodiment, the opening is not secured or fastened in any way and merely provides easy access for deposit and removal of the various effects which a person desires to temporarily store there.

In another embodiment, the inside storage compartment 142 includes an edge 143 that is elasticized along the opening. The elasticized edge 143 provides for additional snugness so that the inside storage compartment 142 is less likely to lose or spill its contents during use of the pet walking pouch 100 in the open configuration.

In yet another embodiment (not shown), the inside storage compartment 142 includes an edge 143 that includes a fastener coinciding with the opening. As noted above, in such an embodiment, a fastener is used to more securely seal the opening so that any effects stored therein cannot be lost during a walk when the fastener is in a closed configuration and the pet walking pouch 100 is in an open configuration. It should be readily understood that there are many type fasteners that are effective for sealing such an opening, including but not limited to zippers, snaps, buttons, and hook-and-loop fasteners (such as VELCRO®), among others. It is intended that any and all such known fasteners be included within the scope of this disclosure.

In FIG. 10, the rear view of the pet walking pouch 100 in the open configuration illustrates that the over-panel 120a and the under-panel 120b are a one-piece panel made from the same material. Of course, in alternative embodiments, the over-panel 120a and the under-panel 120b could also be separate pieces joined together anywhere along their common points. Ease of manufacture will most likely cause these panels to be made from the same piece in most instances.

It should be noted that the front storage compartment 124 and the rear storage compartment 125 are both visible above and below the ring fasteners 112. The openings of both the front storage compartment 124 and the rear storage compartment 125 are toward the ring fasteners 112. It will be noted in this configuration also that the under-panel 120b is folded completely down and “under” the over-panel 120a. It should also be apparent that the terms front storage compartment 124 and rear storage compartment are to be understood less literally in this open configuration.

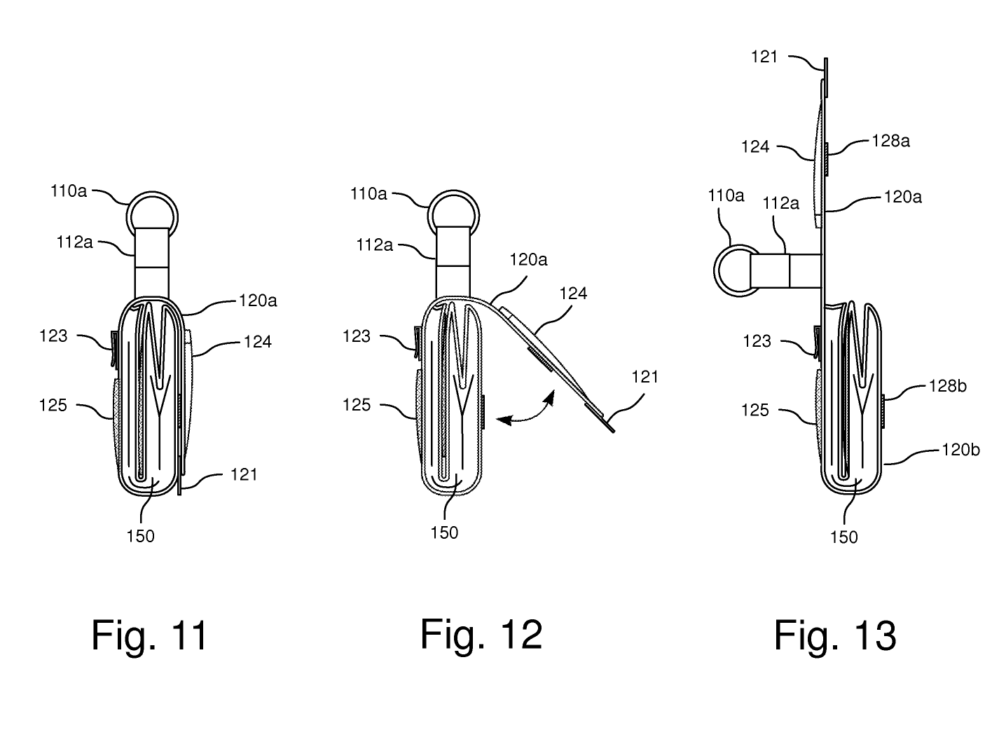

FIG. 11-FIG. 15 collectively illustrate the opening of a pet walking pouch 100 as viewed from the side. FIG. 11 is a side view of the pet walking pouch 100 in a compact configuration. In the illustrated embodiment, one end 150 of the pet walking pouch 100 is visible and the front storage compartment 124 is apparent on the over-panel 120a while the rear storage compartment 125 is apparent on the over-panel 120a on the rear of the pet walking pouch 100. It should be noted that the belt clip 123 is readily apparent also on the rear of the pet walking pouch 100, that is, the portion which would be near a person wearing the pet walking pouch on a belt or other similar arrangement.

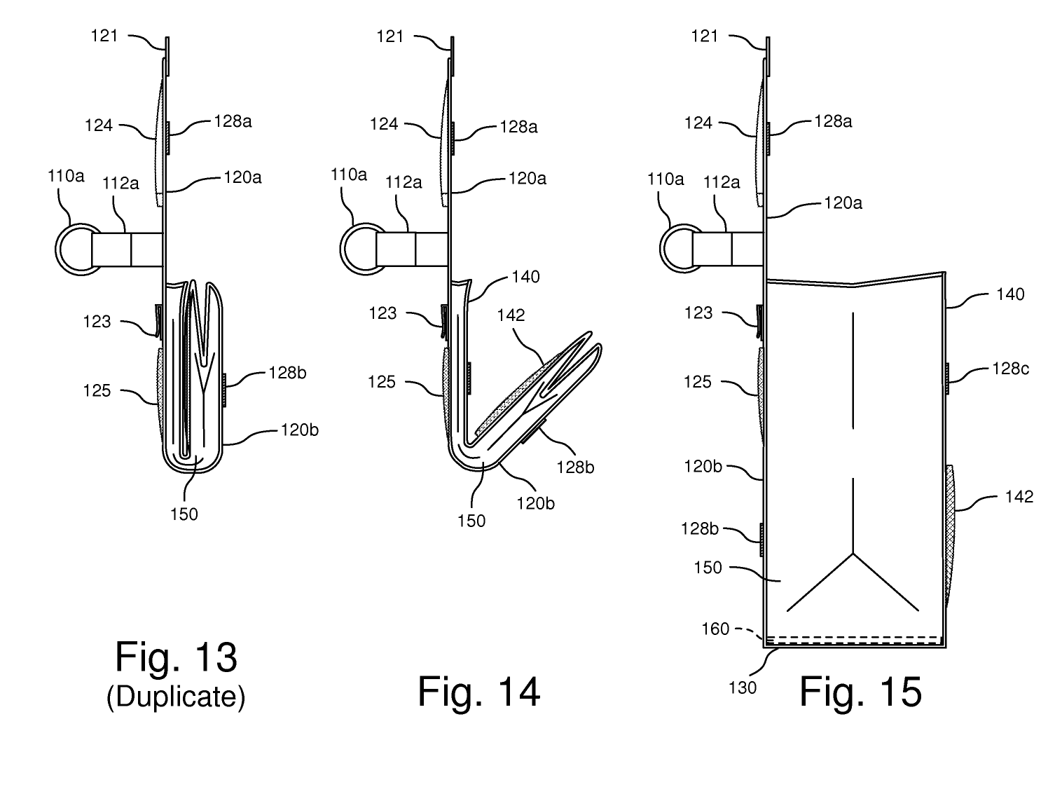

FIG. 12 is a side view of the pet walking pouch 100 with the front flap being lifted to open. A person may grasp the tab 121 to lift the over-panel 120a, or front panel, of the pet walking pouch 100 to begin the opening process. The front panel or over-panel 120a is then extended to a complete upright position as in FIG. 13. In the illustrated embodiment, FIG. 13 is a side view of the pet walking pouch 100 with the front panel or over-panel 120a being completely opened.

FIG. 14 is a side view of the pet walking pouch 100 with the front flap or over-panel 120a being completely opened and the lower portion of the pet walking pouch 100 being folded downward to expand and open. If gravity doesn't cause the lower portion to completely unfold, the person may pull the lower portion down and, if necessary, shake the pet walking pouch 100 slightly to cause the inner compartment 144 to completely open as shown in FIG. 15.

FIG. 15 is a side view of the pet walking pouch 100 with the over-panel 120a or front flap being completely opened while the lower portion, including the main or inner compartment 144 is completely expanded and open. A substantially rigid card 160 (or plate) is located across the bottom or base 130 inside the inner compartment 144 of the pet walking pouch 100. This card 160, while substantially rigid, does not prevent the base 130 from folding upward when the pet walking pouch 100 is in a more compact configuration. In one embodiment, the card 160 includes a fold-line (not shown) providing for the card 160 to fold along the same lines as the base 130 of the pet walking pouch 100 when being closed or compacted.

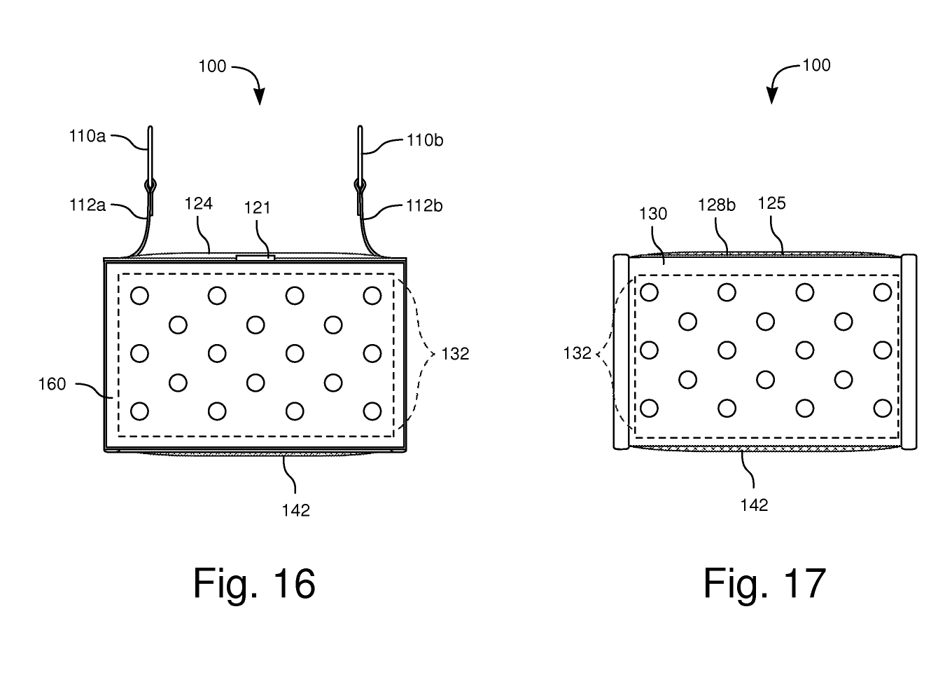

FIG. 16 is a top view of the pet walking pouch 100 with the lower portion completely expanded and open, and FIG. 17 is a bottom view of the pet walking pouch 100 with the lower portion completely expanded and open. After removing a soiled waste disposal bag from within the inner compartment 144, thorough rinsing or cleaning may sometimes be necessary. The base 130 of the pet walking pouch 100 includes a number of drain holes 132 to provide for rinsing and/or draining while cleaning the inner compartment 144. While a particular pattern of drain holes 132 is illustrated in FIG. 16-17, it should be evident that any suitable pattern of drain holes 132 providing for both structure and drainage is suitable.

A platform or card 160 is inserted within the inner compartment 144 above the base 130 of the pet walking pouch 100. The card 160 includes a hole pattern 132 to match the hole pattern of the base 130 of the pet walking pouch 100. The card 160 provides a slightly rigid structure to the base 130 of the pet walking pouch 100 so that it will stand rather than fall over, if need be, and prevent any contents from spilling out. In one embodiment, the card 160 includes a fold line coinciding with any fold lines along the base 130 of the pet walking pouch 100.

From the foregoing description, it will be recognized by those skilled in the art that a pet walking pouch 100 having multiple compartments that provide storage for unused waste bags as well as personal effects that a person can keep with them while walking their pet has been provided. The pet walking pouch 100 is foldable and unfolds via a tri-fold configuration to provide a large inner compartment 144 for storage of soiled waste bags that contain any waste left by the pet during the walk.

The pet walking pouch 100 includes a pair of ring fasteners 110a, 110b for attaching a shoulder strap for ease of carrying. In various embodiments, the pet walking pouch 100 includes a front storage compartment 124, a rear storage compartment 125, and/or an inside storage compartment 142 for securing personal effects during a walk. The storage compartments may be of mesh, or of the same flexible material from which the pet walking pouch is made. In some embodiments, the storage compartments include fasteners for securing the contents placed therein.

The pet walking pouch 100 includes many features that differentiate from currently existing products. A compact tri-fold design provides for a much smaller carry-size. The bottom of the expanded inner section of the pet walking pouch 100 includes drain holes for easy cleaning and rinsing of the pouch when soiled during use. The pet walking pouch 100 also includes multiple additional compartments for storage of unused waste disposal bags as well as personal effects during a pet walk. A highly visible identification tag holder window is also available on the outside flap covering the pet walking pouch 100.

The pet walking pouch 100 includes provision for attaching a shoulder strap or for attaching to a leash. Thus, the shoulder strap may be exchanged for a leash, if desired. Since pet owners often do not like or prefer not to carry the waste disposal bag after the pet waste has been cleaned from the walk area, the pet walking pouch 100 makes it simpler to place the soiled waste bag into a container (the pet walking pouch 100) for the remainder of the walk or until a disposal area is located.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A tri-fold bag for containment of items while walking a pet, the tri-fold bag comprising:
a collapsible main compartment section made from a water-resistant flexible material, the collapsible main compartment section having an opening opposite a base when in an open configuration, the base including a plurality of drain holes, and the main compartment section foldable along its length;
a cover flap that is foldable over the opening for enclosing the main compartment section in the open configuration, the cover flap also foldable over the collapsible main compartment section into a tri-fold closed configuration;
at least one fastener strap affixed to the cover flap, each at least one fastener strap including a fastener for attachment of a strap; and
a plurality of secondary compartments for storage of items,
whereby at least one secondary compartment is accessible in the open configuration and at least one secondary compartment is accessible in the tri-fold closed configuration.

2. The tri-fold bag of claim 1, wherein the flexible material includes at least one of the following characteristics:
a plastic-covered and woven water-proof material;
nylon;
polyester;
plastic;
canvas; and
plain-woven fabric.

3. The tri-fold bag of claim 2, wherein the flexible material is water-proof.

4. The tri-fold bag of claim 1, wherein the strap is a shoulder strap removably attachable to each fastener.

5. The tri-fold bag of claim 4, wherein the strap is a leash removably attached to at least one fastener so that the leash is also operable as a shoulder strap.

6. The tri-fold bag of claim 1, further comprising at least one of the following:
a fastener clip affixed to the cover flap, the fastener flip adaptable for securing the tri-fold bag to a belt; and
an identification tag holder affixed to the cover flap, the identification tag holder situated to be visible from multiple directions.

7. The tri-fold bag of claim 1, wherein at least one compartment of the plurality of secondary compartments is sized to accommodate at least one of the following:
a plurality of unused pet waste disposal bags;
a roll of unused pet waste disposal bags; and
a container of unused pet waste disposal bags.

8. The tri-fold bag of claim 1, wherein at least one compartment of the plurality of secondary compartments is an open compartment providing ease of access for insertion and removal of items.

9. The tri-fold bag of claim 1, wherein at least one compartment of the plurality of secondary compartments includes an elasticized opening that provides additional snugness to secure contents within the at least one compartment.

10. The tri-fold bag of claim 1, wherein at least one compartment of the plurality of secondary compartments includes a closure fastener to close the opening and maintain contents within the at least one compartment.

11. A tri-fold bag for containment of items while walking a pet, the tri-fold bag comprising:
a collapsible main compartment section having an opening opposite a base when in an open configuration, the base including a plurality of drain holes, and the main compartment section foldable along its length;
a cover flap that is foldable over the opening for enclosing the main compartment section in the open configuration, the cover flap also foldable over the collapsible main compartment section into a tri-fold closed configuration;
at least one fastener affixed to the cover flap for attachment of a strap; and
a plurality of secondary compartments for storage of items,
whereby at least one secondary compartment is accessible in the open configuration and at least one secondary compartment is accessible in the tri-fold closed configuration.

12. The tri-fold bag of claim 11, wherein the collapsible main compartment section is made from a flexible material that includes at least one of the following characteristics:
a plastic-covered and woven water-proof material;
nylon;
polyester;
plastic;
canvas; and
plain-woven fabric.

13. The tri-fold bag of claim 12, wherein the flexible material is at least one of the following:
water-resistant; and
water-proof.

14. The tri-fold bag of claim 11, further comprising at least one fastener strap, so that each at least one fastener is secured via a respective fastener strap to the cover flap.

15. The tri-fold bag of claim 11, wherein the strap is one of the following:
a shoulder strap removably attachable to each fastener; and
a leash removably attached to at least one fastener so that the leash is also operable as a shoulder strap.

16. The tri-fold bag of claim 11, further comprising at least one of the following:
a fastener clip affixed to the cover flap, the fastener flip adaptable for securing the tri-fold bag to a belt; and
an identification tag holder affixed to the cover flap, the identification tag holder situated to be visible from multiple directions.

17. The tri-fold bag of claim 11, wherein at least one compartment of the plurality of secondary compartments is sized to accommodate at least one of the following:
a plurality of unused pet waste disposal bags;
a roll of unused pet waste disposal bags; and
a container of unused pet waste disposal bags.

18. The tri-fold bag of claim 11, wherein at least one compartment of the plurality of secondary compartments is an open compartment providing ease of access for insertion and removal of items.

19. The tri-fold bag of claim 11, wherein at least one compartment of the plurality of secondary compartments includes an elasticized opening that provides additional snugness to secure contents within the at least one compartment.

20. The tri-fold bag of claim 11, wherein at least one compartment of the plurality of secondary compartments includes a closure fastener to close the opening and maintain contents within the at least one compartment.
